(19) United States
(12) Patent Application Publication
(10) Pub. No.: US 2026/0313211 A1
(43) Pub. Date: Oct. 8, 2026

(54) DISPLAY APPARATUS

(71) Applicant: CANON KABUSHIKI KAISHA, Tokyo (JP)

(72) Inventor: JUN KAWATA, Kanagawa (JP)

(21) Appl. No.: 19/578,288

(22) Filed: Mar. 25, 2026

(30) Foreign Application Priority Data
Apr. 7, 2025 (JP) 2025-062990
Oct. 21, 2025 (JP) 2025-177273

(51) Int. Cl. H04N 23/53; G03B 17/04

(52) U.S. Cl. CPC H04N 23/531; G03B 17/04

(57) ABSTRACT

A display apparatus is provided that includes an apparatus body, a base member, a rotation unit, and a connection member, which includes a first connection line extending from a wiring lead-out opening of the apparatus body and extending in a direction from the first axis toward the second axis, a second connection line extending from the display unit, and a connection portion connecting the first connection line and the second connection line, and the wiring lead-out opening of the apparatus body and the connection portion are disposed along a straight-line direction perpendicular to at least one of the first axis and the second axis.

### BACKGROUND

### Field of the Technology

The present disclosure relates to a display apparatus including a mechanism that enables adjustment of a position of a display surface of a display unit with respect to an apparatus body.

### Description of the Related Art

Some display apparatuses, such as still cameras, include a display unit configured to adjust an orientation of a surface for displaying a captured image and the like.

International Patent Publication No. WO 2024/038803 discusses a display unit of a display apparatus that is rotatably supported by an operation of a rotation mechanism extending from the apparatus body to the display unit.

International Patent Publication No. WO 2024/038803 illustrates (see FIG. 7) a display apparatus that includes a flexible printed wiring board extending from the inside of the apparatus body, a coaxial cable extending from the inside of the display unit, and a connection connector for connecting the flexible printed wiring board and the coaxial cable, with the apparatus body and the display unit electrically connected. In a first mechanism unit, a pair of bearing portions spaced apart from each other is provided in an axial direction of a rotation axis, and a flexible printed wiring board is located between the pair of bearing portions and is also located outside of one of the bearing portions.

In the display apparatus discussed in International Patent Publication No. WO 2024/038803, the flexible printed wiring board is to be extended at least in a direction substantially parallel to the rotation axis of the first mechanism unit toward a second mechanism unit from between the bearing portions in a range in which the flexible printed wiring board extends from the inside of the apparatus body and is led into the second mechanism unit. Accordingly, the display apparatus requires a length extending in two axial directions, which tends to increase cost.

### SUMMARY

The present disclosure is directed to providing a display apparatus capable of reducing costs as compared with the related art.

An aspect of the present disclosure provides a display apparatus includes an apparatus body, a display unit including a display surface, a first base, a second base, a rotation unit configured to rotatably support the display unit with respect to the apparatus body, and a connection member configured to electrically connect the apparatus body and the display unit. The first base is rotatably supported about a first axis with respect to the apparatus body. The second base is rotatably supported with respect to the first base about a second axis parallel to the first axis. The first base and the second base are provided between the apparatus body and the display unit. The rotation unit includes the first axis, the second axis, and a third axis that is perpendicular to the first axis in a stored state in which the display unit is stored in the apparatus body, the display unit being rotatable with respect to the second base about the third axis. The connection member includes a first connection line extending from a wiring lead-out opening of the apparatus body and extending in a direction from the first axis toward the second axis, a second connection line extending from the display unit, and a connection portion connecting the first connection line and the second connection line. The wiring lead-out opening of the apparatus body and the connection portion are disposed along a direction perpendicular to at least one of the first axis and the second axis.

Features of the present disclosure will become apparent from the following description of embodiments with reference to the attached drawings. The following description of embodiments is described by way of example.

### BRIEF DESCRIPTION OF THE DRAWINGS

FIG. 1A is an external view of a display apparatus according to a first embodiment as viewed from the front of the display apparatus, and FIG. 1B is an external view of the display apparatus according to the first embodiment as viewed from a rear side of the display apparatus.

FIG. 2 is an exploded perspective view illustrating a configuration of a rotation mechanism unit of the display apparatus according to the first embodiment.

FIG. 3A is an external view illustrating a state where a display unit of the display apparatus according to the first embodiment is rotated by a first mechanism unit as viewed from the rear side, FIG. 3B is an external view illustrating the state where the display unit of the display apparatus according to the first embodiment is rotated by the first mechanism unit as viewed from a bottom side of the display apparatus, and FIG. 3C is an external view illustrating the state where the display unit of the display apparatus according to the first embodiment is rotated by the first mechanism unit as viewed from a side surface of the display apparatus.

FIG. 4A is an external view illustrating the state where the display unit of the display apparatus according to the first embodiment is rotated by the rotation mechanism unit as viewed from the front side of the display apparatus, FIG. 4B is an external view illustrating the state where the display unit of the display apparatus according to the first embodiment is rotated by the rotation mechanism unit as viewed from the bottom side, and FIG. 4C is an external view illustrating the state where the display unit of the display apparatus according to the first embodiment is rotated by the rotation mechanism unit as viewed from the back side.

FIG. 5A is a perspective view illustrating the display unit and the rotation mechanism unit according to the first embodiment, FIG. 5B is an exploded perspective view illustrating the display unit and the rotation mechanism unit according to the first embodiment, and FIG. 5C is a perspective view illustrating the display unit and the rotation mechanism unit according to the first embodiment.

FIG. 6A is a plan view illustrating the display unit and a second mechanism unit according to the first embodiment, and FIG. 6B is a perspective view illustrating the display unit and the second mechanism unit according to the first embodiment.

FIG. 7 is a perspective view illustrating a body-side connection line extending outward from a wiring lead-out opening of an apparatus body when the display apparatus is viewed from the rear side.

FIG. 8 illustrates a plan view and a sectional view taken along a straight line passing through a bracket according to the first embodiment.

FIG. 9A is a plan view illustrating a routing for a connection member according to the first embodiment, and FIG. 9B is a plan view illustrating a routing for the connection member according to the first embodiment.

FIG. 10A is a perspective view illustrating a routing for a connection member according to a second embodiment, and FIG. 10B illustrates a plan view and a sectional view taken along a straight line passing through a bracket according to the second embodiment.

FIG. 11 is a perspective view in a case where a bracket is not provided according to the second embodiment.

FIG. 12 is a perspective view illustrating a display unit and a rotation mechanism unit according to a third embodiment.

FIG. 13A is a plan view illustrating a routing for a connection member according to a fourth embodiment, FIG. 13B is a plan view illustrating a routing for a connection member according to a fifth embodiment, and FIG. 13C is a plan view illustrating a routing for a connection member according to a sixth embodiment.

FIG. 14A is a perspective view illustrating a display unit and a rotation mechanism unit according to a seventh embodiment, and FIG. 14B is a perspective view illustrating the display unit and the rotation mechanism unit according to the seventh embodiment as viewed from the bottom side.

FIG. 15A is an exploded perspective view illustrating the display unit according to the seventh embodiment, FIG. 15B illustrates a plan view and a sectional view of the display unit according to the seventh embodiment, FIG. 15C is a side view of the display unit according to the seventh embodiment, and FIG. 15D is a projection view of the display unit according to the seventh embodiment.

### DESCRIPTION OF THE EMBODIMENTS

### First Embodiment

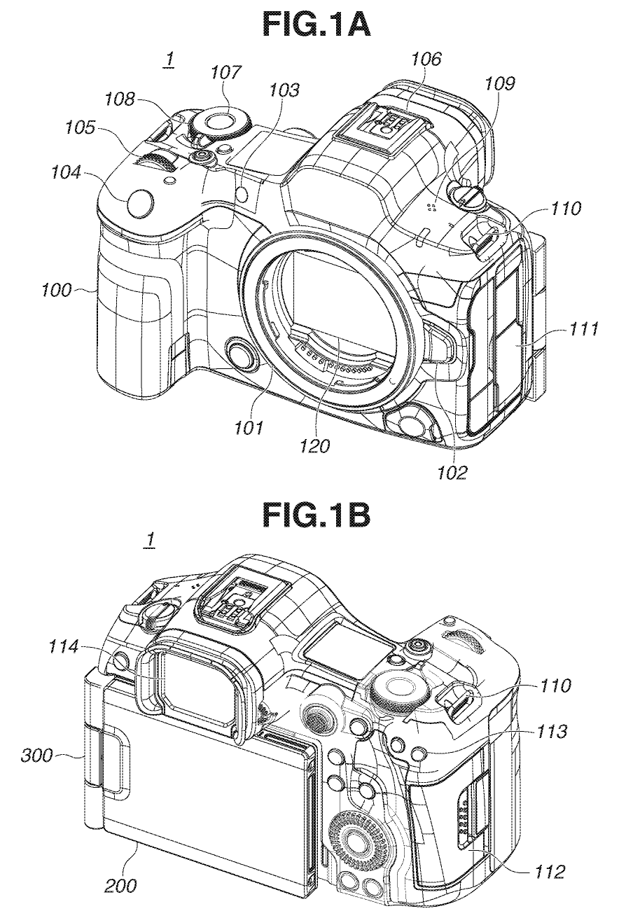

Embodiments of the present disclosure will be described in detail below with reference to the accompanying drawings. FIGS. 1A and 1B are external views illustrating a display apparatus 1 according to a first embodiment of the present disclosure. FIG. 1A is a perspective view illustrating a main body of the display apparatus 1 as viewed from the front in a stored state where a display unit 200 is stored in the apparatus body of the display apparatus 1. FIG. 1B is a perspective view illustrating the main body of the display apparatus 1 as viewed from the rear in the stored state where the display unit 200 is stored in the apparatus body of the display apparatus 1.

On the front side of an apparatus body 100 of the display apparatus 1, a lens mount 101 for mounting an image capturing lens barrel, a lock release button 102 for detaching the image capturing lens barrel from the lens mount 101, and an autofocus (AF) assist light window 103 are provided. On the top side of the apparatus body 100, a release button 104, an electronic dial 105, an accessory shoe 106, a mode button 107, a moving image capturing button 108, and a speaker 109 are provided.

On the lateral side surfaces of the apparatus body 100, a strap hole 110 through which a neck strap for preventing accidental dropping of the apparatus body 100 can be passed is provided. A connector cover 111 is provided on a right side surface of the apparatus body 100 when viewed from the front, and a media cover 112 is provided on a left side surface of the apparatus body 100 when viewed from the front. The connector cover 111 is openable and closable with respect to the apparatus body 100, and, in a closed state, covers a group of terminals, including an analog video terminal, a power supply terminal, and a digital terminal. The media cover 112 is openable and closable with respect to the apparatus body 100, and, in the closed state, covers a card slot for storing a storage medium, such as a semiconductor memory card.

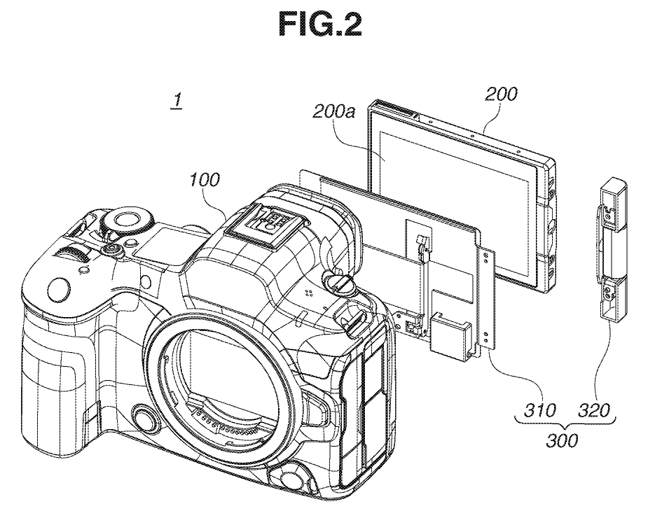

On the rear side of the apparatus body 100, operation buttons 113 for performing various operations and an electronic viewfinder 114 are provided. On the rear side of the apparatus body 100, the display unit 200, which includes a display surface 200a (FIG. 2) and a display control board for controlling driving of the display surface 200a, is rotatably supported by a rotation mechanism unit 300, also referred to as rotation unit, as described below.

The apparatus body 100 includes an image sensor 120, such as a charge-coupled device (CCD) image sensor or a complementary metal-oxide semiconductor (CMOS) image sensor, and an apparatus control board for controlling driving of the display apparatus 1.

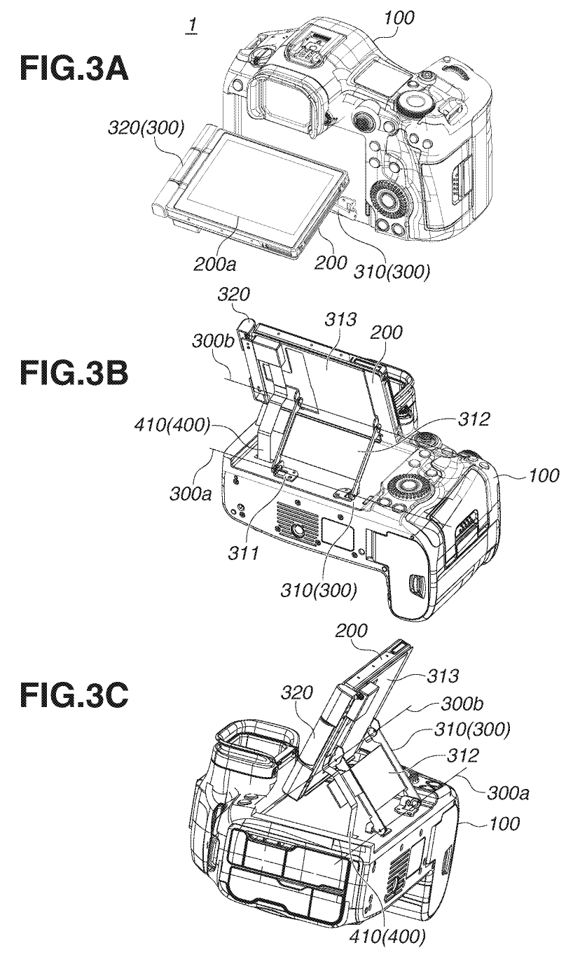

Position adjustment of the display unit 200 of the display apparatus 1 will be described. FIG. 2 is an exploded perspective view illustrating a configuration example of the rotation mechanism unit 300 of the display apparatus 1 according to the first embodiment. FIGS. 3A to 3C are external views each illustrating a state where the display unit 200 according to the first embodiment is rotated by the rotation mechanism unit 300. FIG. 3A is a perspective view illustrating a state where the display unit 200 is rotated by a first mechanism unit 310 as viewed from the rear of the display apparatus 1. FIG. 3B is a perspective view illustrating a state where the display unit 200 is rotated by a second mechanism unit 320 as viewed from the bottom of the display apparatus 1.

FIG. 2 illustrates a configuration example of the rotation mechanism unit 300 that includes the first mechanism unit 310 and the second mechanism unit 320 and rotatably supports the display unit 200 with respect to the apparatus body 100 so as to allow a position of the display surface 200a to be adjusted to a desired position.

A rotational movement using the first mechanism unit 310 and the second mechanism unit 320 illustrated in FIGS. 3A to 3C will be described below. A first base 312 is formed between the apparatus body 100 and the display unit 200. The first base 312 is rotatably supported with respect to the apparatus body 100 about a first axis 300a, which is disposed on the apparatus body 100 side of a part of the first mechanism unit 310 to be described below. A second base 313 that is disposed on the rear side of the display unit 200 is rotatably supported with respect to the first base 312 about a second axis 300b that is formed in parallel to the first axis 300a above the first base 312.

As illustrated in FIGS. 3A to 3C, the first mechanism unit 310 (tilt mechanism) allows the first base 312 to be tilted about the first axis 300a with respect to the rear surface of the display apparatus 1. Further, the first mechanism unit 310 enables the display unit 200 and the second base 313, which is formed by another component on the rear side of the display unit 200, to be tilted about the second axis 300b with respect to the first base 312. With this configuration, for example, the display surface 200a is directed toward a top side, thereby making it possible to adjust the position of the display surface 200a to an orientation suitable for low-angle image capturing.

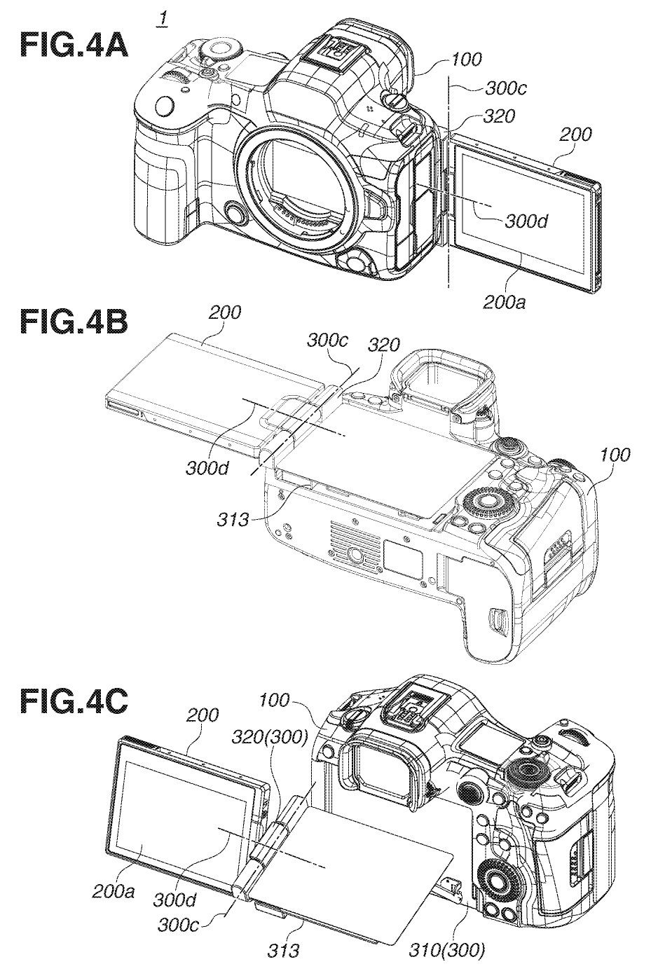

The second mechanism unit 320 (vari-angle mechanism) as illustrated in FIGS. 4A to 4C will be described. In the stored state (FIGS. 1A and 1B) where the display unit 200 is stored in the apparatus body 100, the second mechanism unit 320 rotatably supports the display unit 200 with respect to the second base 313 about a third axis 300c, which is formed perpendicularly to the first axis 300a. Further, the second mechanism unit 320 rotatably supports the display unit 200 with respect to the second base 313 about a fourth axis 300d that is formed perpendicularly to the third axis 300c.

Thus, the position of the display surface 200a may be adjusted to, for example, an orientation suitable for self-portrait image capturing by the display surface 200a being directed toward a subject. The first mechanism unit 310 and the second mechanism unit 320 may be configured to rotate simultaneously, or may be configured to rotate independently. The rotation unit includes at least the first axis 300a, the second axis 300b, and the third axis 300c and rotatably supports the display unit 200 with respect to the apparatus body 100.

Accordingly, the first base 312 rotates with respect to the apparatus body 100, the second base 313 and the display surface 200a rotate with respect to the first base 312, and the display surface 200a rotates with respect to the second base 313. With this configuration, the degrees of freedom of the position and orientation of the display surface 200a with respect to the apparatus body 100 are increased, enabling image capturing from various angles. The rotation of these members improves the usability of the display apparatus 1 during image capturing and enhances convenience.

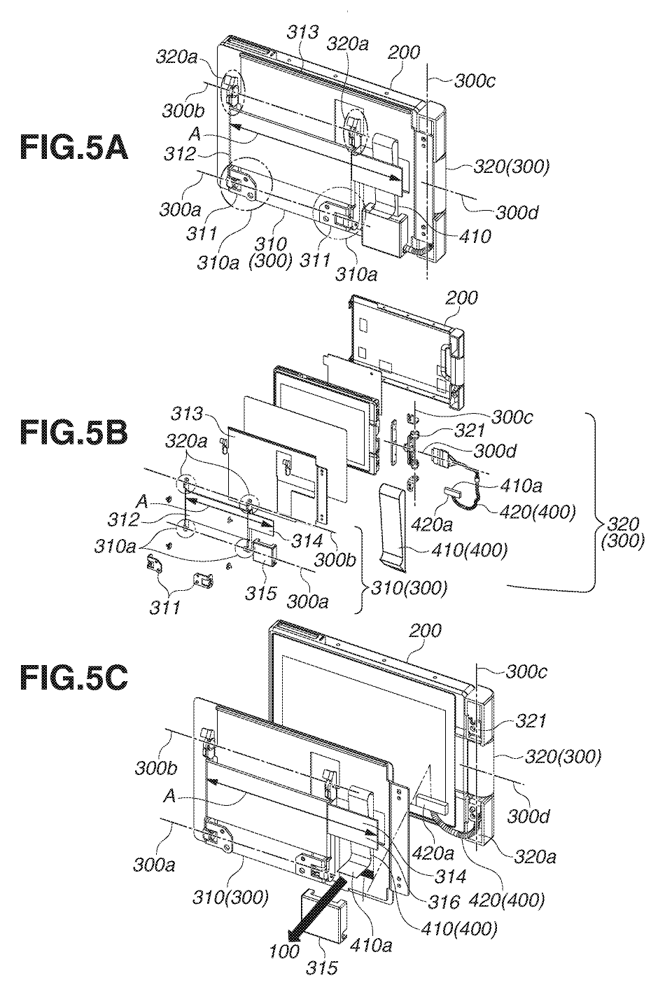

An internal structure of the rotation mechanism unit 300 of the display apparatus 1 will be described. FIGS. 5A to 5C are perspective views illustrating the display unit 200 and the rotation mechanism unit 300 according to the first embodiment. FIG. 5A is a perspective view illustrating the display unit 200 and the rotation mechanism unit 300 according to the first embodiment. FIG. 5B is an exploded perspective view illustrating the display unit 200 and the rotation mechanism unit 300 according to the first embodiment. FIG. 5C is an exploded perspective view illustrating the display unit 200, the first mechanism unit 310, and the second mechanism unit 320 according to the first embodiment. For clarity, the apparatus body 100 is not illustrated in FIG. 5B.

The first mechanism unit 310 of the rotation mechanism unit 300 includes a mechanism that allows the display unit 200 to rotate in an up-and-down direction with respect to the apparatus body 100 about the first axis 300a, which is perpendicular to an optical axis of the display apparatus 1, and to rotate about the second axis 300b parallel to the first axis 300a.

The first mechanism unit 310 has a structure in which a shaft is fitted into through-holes formed in stands 311 made of a metal plate material and the first base 312, thereby defining the first axis 300a and forming a pair of bearing portions 310a spaced apart from each other along the first axis 300a. Each stand 311 includes a body-side fixing portion for the first mechanism unit 310 (tilt mechanism) and a hole serving as a bearing for the first axis 300a. A shaft is fitted into through-holes formed in the first base 312 made of a metal plate material and the second base 313, thereby defining the second axis 300b and forming a pair of bearing portions 320a spaced apart from each other along the second axis 300b. The first mechanism unit 310 includes a wiring bracket 314 and a connection portion cover 315 as described below.

The bearing portions 310a and 320a that define the axes may be provided in any number, as long as two or more are provided.

The second mechanism unit 320 allows, in the stored state where the display unit 200 is stored in the apparatus body 100, the display unit 200 to rotate about the third axis 300c that is perpendicular to at least one of the first axis 300a and the second axis 300b, and to rotate about the fourth axis 300d that is orthogonal to the third axis 300c.

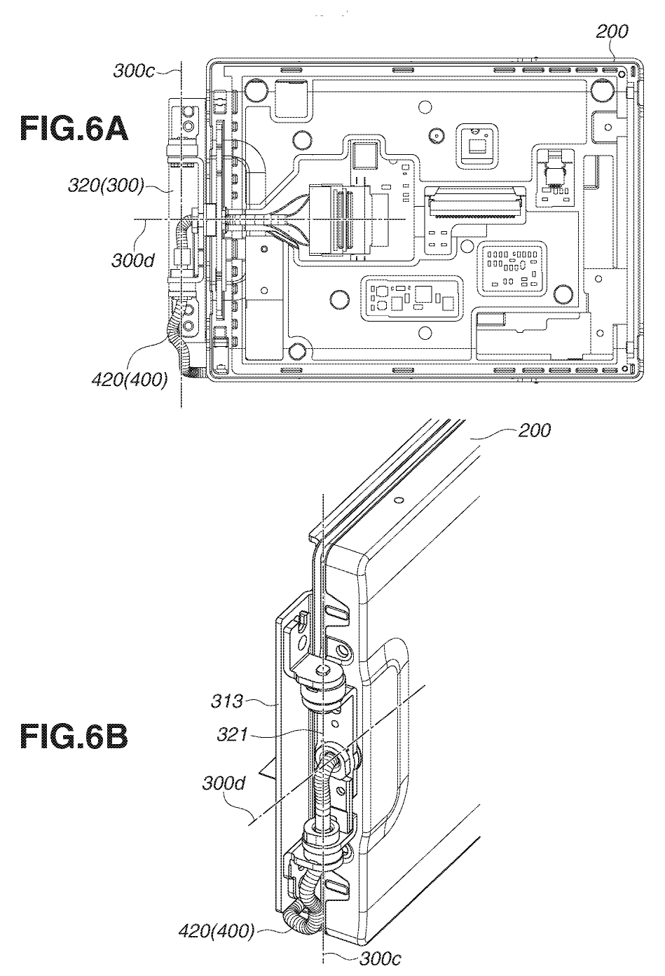

As illustrated in FIG. 5B, the second mechanism unit 320 includes a metal plate material and/or a spring material, and includes a second mechanism assembly 321 that forms bearing portions for the third axis 300c and the fourth axis 300d. The second mechanism assembly 321 includes a tubular member defining the fourth axis 300d, and a part of a display-side connection line 420 extending from the display unit 200 to the apparatus body 100 is passed through the tubular member toward the display unit 200 as illustrated in FIGS. 6A and 6B.

FIG. 5C illustrates a state where the first mechanism unit 310 supports a body-side connection line 410 of a connection member 400 that connects to the apparatus control board in the apparatus body 100. A portion of the body-side connection line 410 that extends from a wiring lead-out opening of the apparatus body, also referred to as a body wiring lead-out opening, 100a of the apparatus body 100 and extends in a direction from the first axis 300a toward the second axis 300b, also referred to as a first connection line. The second mechanism unit 320 supports the display-side connection line 420 that connects to the display control board in the display unit 200. The display-side connection line 420 extending from the display unit 200 is also referred to as a second connection line.

The body-side connection line 410 and the display-side connection line 420 are electrically connected to each other via connection portions 410a and 420a that are provided on the first mechanism unit 310. In the present embodiment, a mating direction of the connection portions 410a and 420a is set to be substantially parallel to the first axis 300a in the first embodiment. However, the present disclosure is not limited thereto, and the mating direction of the connection portions 410a and 420a may be set to be substantially parallel to the third axis 300c. Similarly, the first connection line and the second connection line are electrically connected to each other via the connection portions 410a and 420a.

As in the first embodiment, the connection portions 410a and 420a are disposed such that a mating direction thereof is parallel to the first axis 300a and the second axis 300b (tilt rotation axes). With this configuration, the body-side connection line 410 is routed back toward the connection portion 410a from the second axis 300b toward the first axis 300a, and the display-side connection line 420 extends to the connection portion 420a from the first axis 300a toward the second axis 300b, so that the two connection lines can be easily connected while facing each other.

A path for the connection member 400 will be described. The connection member 400 collectively includes a portion of the body-side connection line 410 that extends outward from the body wiring lead-out opening 100a, a part of the display-side connection line 420, and the connection portions 410a and 420a.

FIGS. 6A and 6B illustrate a plan view and a perspective view, respectively, of the display unit 200 and the second mechanism unit 320 according to the first embodiment. FIG. 6A is a plan view illustrating an internal structure of the display unit 200 and the second mechanism unit 320 according to the first embodiment. FIG. 6B is a perspective view illustrating the display unit 200 and the second mechanism unit 320 according to the first embodiment.

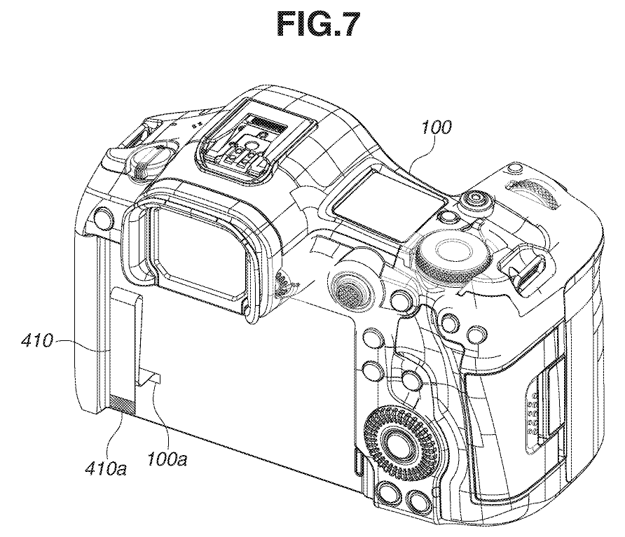

FIG. 7 is a perspective view illustrating the body-side connection line 410 extending outward from the body wiring lead-out opening 100a according to the first embodiment when the display apparatus 1 is viewed from the rear side.

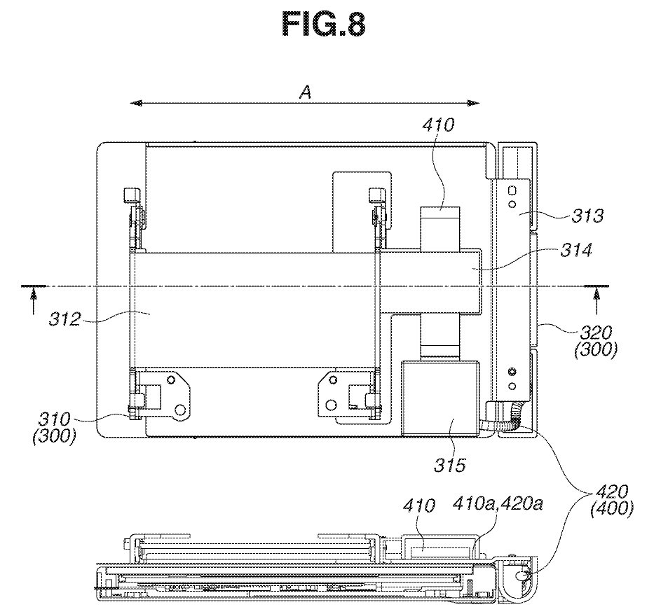

FIG. 8 illustrates a plan view and a sectional view taken along a straight line passing through the wiring bracket 314 according to the first embodiment.

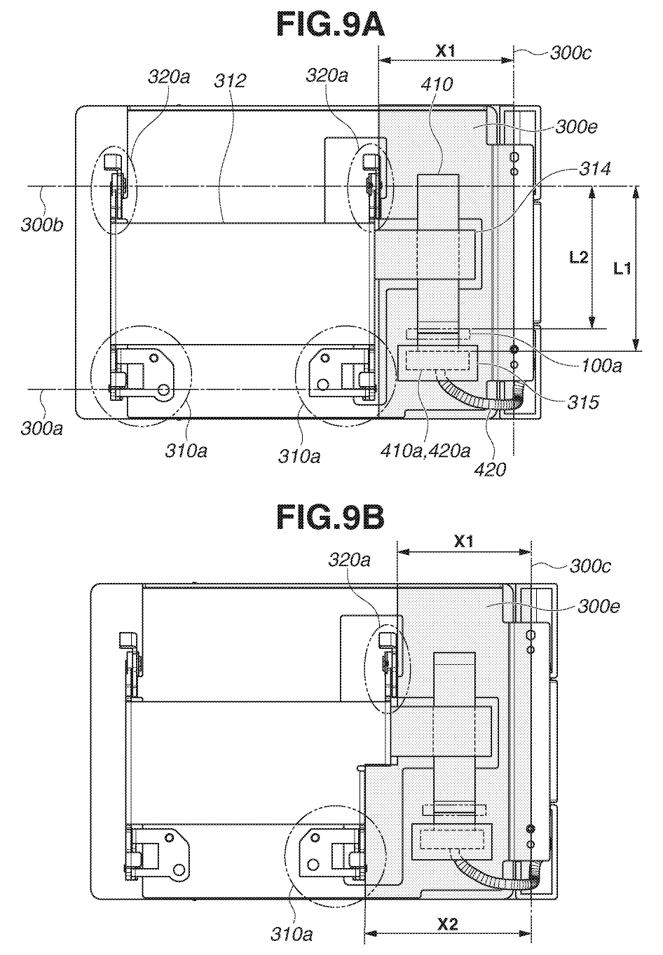

FIG. 9A is a front view illustrating a structure in which one bearing portion of the pair of bearing portions 310a and one bearing portion of the pair of bearing portions 320a are disposed equidistant from the third axis 300c.

FIG. 9B is a front view illustrating a structure in which one bearing portion of the pair of bearing portions 310a and one bearing portion of the pair of bearing portions 320a are disposed at different distances from the third axis 300c.

As illustrated in FIG. 7, on the rear side of the apparatus body 100, the body wiring lead-out opening 100a is provided which serves as an outlet through which the connection member 400 extends from the apparatus body 100 to the outside.

As illustrated in FIGS. 5A and 5C and 7, the body-side connection line 410 extends out of the apparatus body 100 through the body wiring lead-out opening 100a, which is provided in the vicinity of the first axis 300a, and is bent in the vicinity of the second axis 300b. Further, a portion of the body-side connection line 410 extending outward through the body wiring lead-out opening 100a and a portion of the body-side connection line 410 that is folded back after the bending overlap each other (a first region), and are connected to the display-side connection line 420 via the connection portions 410a and 420a. FIG. 5A illustrates the stored state where the display unit 200 is stored in the apparatus body 100.

Disposing the connection member 400 from the vicinity of the first axis 300a to the vicinity of the second axis 300b contributes to supporting a tilt angle. However, the connection member 400 can be disposed at an appropriate distance from the first axis 300a and/or the second axis 300b, as needed.

As illustrated in FIGS. 5A and 5C and 8, the body-side connection line 410 is supported, with double-sided tape or the like, by a wiring bracket 314 disposed between the body wiring lead-out opening 100a and the second axis 300b. The wiring bracket 314 is fastened to the first base 312 or is formed along an extending direction A of the first base 312. With this configuration, the externally exposed area of the body-side connection line 410 can be reduced. In addition, the body-side connection line 410 can be guided in accordance with a tilt motion, and unintended movement can be restricted.

In the first embodiment, as illustrated in FIG. 9A, a region is defined between the third axis 300c and the bearing portion 310a and the bearing portion 320a that are closest to the third axis 300c among a plurality of bearing portions forming the first axis 300a and the second axis 300b. The body-side connection line 410 and the connection portions 410a and 420a are disposed in this region. This also means that, in a stored state in which the display unit 200 is stored in the apparatus body 100, the body-side connection line 410 is disposed in a wiring path range 300e that does not overlap the first base 312 in the optical axis direction. FIGS. 9A and 9B illustrate the stored state in which the display unit 200 is stored in the apparatus body 100.

With this configuration, the thickness of the base portion in the optical axis direction in the stored state in which the display unit 200 is stored in the apparatus body 100 can be reduced. As illustrated in FIG. 9B, even when the bearing portion 310a and the bearing portion 320a that are closest to the third axis 300c are located at different distances X1 and X2, respectively, from the third axis 300c, the connection member 400 is also located in the wiring path range 300e.

The connection portions 410a and 420a are disposed closer to the first axis 300a than to the second axis 300b, and the body wiring lead-out opening 100a is disposed closer to the second axis 300b than the connection portions 410a and 420a are. In this case, a distance L1 between the second axis 300b and the connection portions 410a and 420a is longer than a distance L2 between the second axis 300b and the body wiring lead-out opening 100a. Accordingly, when the display unit 200 is stored in the apparatus body 100, the body-side connection line 410 does not overlap the connection portions 410a and 420a in the optical axis direction, and thus is less likely to hinder reduction in thickness of the display apparatus 1.

The connection portions 410a and 420a of the connection member 400 are covered with the connection portion cover 315 for water-proofing, dust-proofing, and other purposes.

As described above, according to the first embodiment, the body wiring lead-out opening 100a through which the body-side connection line 410 extends to the outside of the apparatus body 100 and the connection portions 410a and 420a are aligned along a straight line extending in a direction perpendicular to at least one of the first axis 300a and the second axis 300b. This eliminates the need to extend the body-side connection line 410 in two directions corresponding to two axes so as to connect the body-side connection line 410 and the display-side connection line 420.

Consequently, not only can the configuration be simplified, but also the length, in a direction perpendicular to a tilt axis or axes, along which the body-side connection line 410 is extended to connect to the display-side connection line 420, can be reduced.

It is assumed herein that a flexible printed wiring board (FPC) is used as the body-side connection line 410, a thin coaxial cable is used as the display-side connection line 420, and connectors are used as the connection portions 410a and 420a. However, the present disclosure is not limited thereto, and a flexible flat cable (FFC) and the like may also be used. Since a flexible printed wiring board is susceptible to electrostatic discharge (ESD), if a portion to be replaced with a thin coaxial cable can be increased by reducing the length of the flexible printed wiring board even without changing the overall length, a display apparatus with excellent ESD resistance can be provided.

If the connection member 400 is disposed in the wiring path range 300e, the connection member 400 does not overlap the first base 312, so that the thickness of the rotation mechanism unit 300 can be reduced as compared with a case where the connection member 400 is disposed in a region outside the wiring path range 300e.

### Second Embodiment

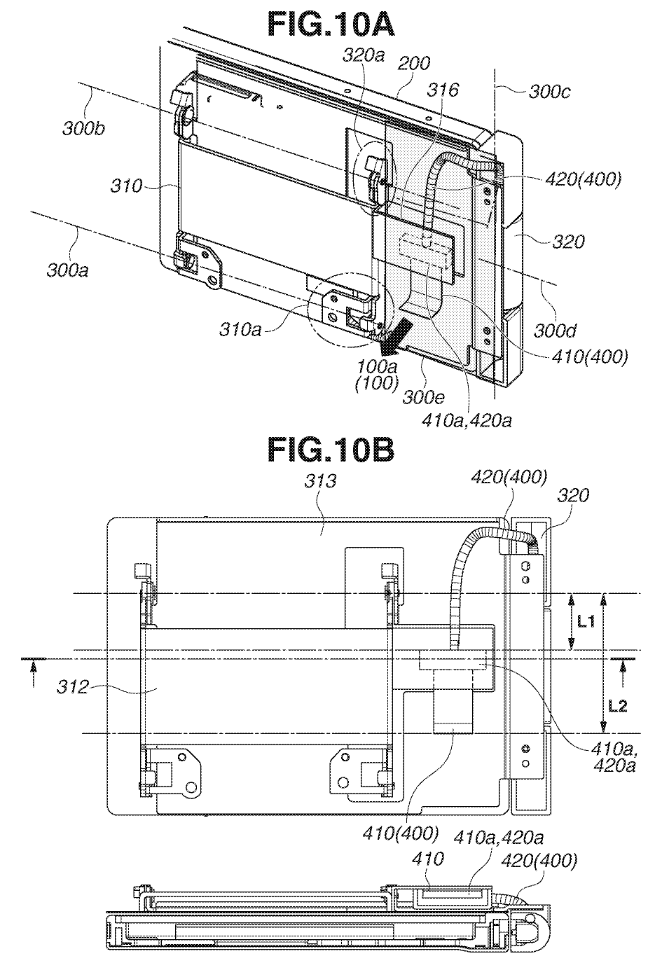

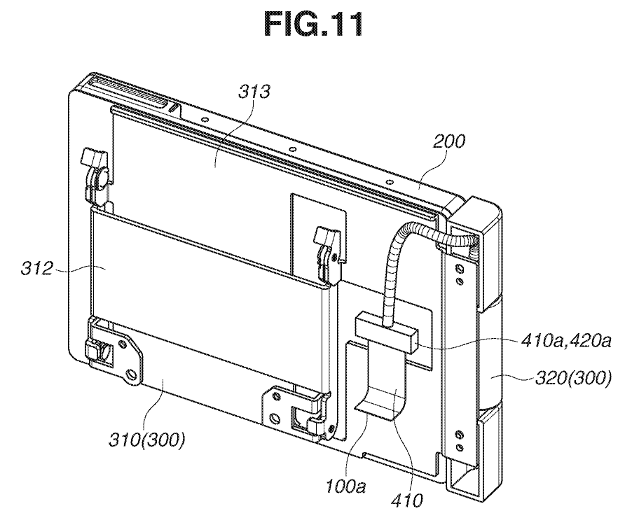

A second embodiment of the present disclosure will be described. FIG. 10A is a perspective view illustrating a routing of the connection member 400 according to the second embodiment. FIG. 10B illustrates a plan view and a sectional view taken along a line passing through the wiring bracket 314 according to the second embodiment. FIG. 11 is a perspective view illustrating a case where the wiring bracket 314 is omitted according to the second embodiment.

An outline of the second embodiment is similar to that of the first embodiment, and differences between the embodiments are described below.

As illustrated in FIGS. 10A and 10B, the connection member 400 includes a body-side connection line 410 connected to an apparatus control board in the apparatus body 100 and a display-side connection line 420 connected to a display control board in the display unit 200. The body-side connection line 410 and the display-side connection line 420 are electrically connected to each other via connection portions 410a and 420a. In this case, a wiring path range 300e is defined between the third axis 300c and bearing portions 310a and 320a that are closest to the third axis 300c among a plurality of bearing portions forming the first axis 300a and the second axis 300b, and the wiring path range 300e does not overlap the first base 312. The body-side connection line 410 is disposed in the wiring path range 300e.

The body-side connection line 410 of the connection member 400 is electrically connected to the display-side connection line 420 via the connection portions 410a and 420a, where the connection portions 410a and 420a are disposed between the body wiring lead-out opening 100a of the apparatus body 100 and the second axis 300b.

In the first embodiment, the body-side connection line 410 is fastened to the first base 312 of the first mechanism unit 310, or is supported by a wiring bracket 314 formed along an extending direction A of the first base 312. In contrast, in the present embodiment, the connection portions 410a and 420a are supported on the wiring bracket 314 with double-sided tape or the like. The connection portions 410a and 420a may be supported or fixed on the second base 313 instead of the wiring bracket 314. Alternatively, the connection portions 410a and 420a and the body-side connection line 410 may both be supported on the same wiring bracket 314, or may be supported on separately provided wiring brackets 314.

FIG. 10B illustrates a state in which the body wiring lead-out opening 100a is disposed closer to the first axis 300a than to the second axis 300b, and the connection portions 410a and 420a are disposed closer to the second axis 300b than is the body wiring lead-out opening 100a. In this case, a distance L1 between the second axis 300b and the connection portions 410a and 420a is shorter than a distance L2 between the second axis 300b and the body wiring lead-out opening 100a.

In the second embodiment, the display-side connection line 420 extends from the vicinity of the second axis 300b. Therefore, the body-side connection line 410, which extends from the body wiring lead-out opening 100a provided in the vicinity of the first axis 300a, extends toward the second axis 300b without being folded back (i.e., without forming the first region). The body-side connection line 410 is electrically connected to the display-side connection line 420 via the connection portions 410a and 420a. Further, the display-side connection line 420 extends from the vicinity of the second axis 300b and is connected to the display unit 200 via the second mechanism unit 320, which defines the third axis 300c and the fourth axis 300d.

As described above, according to the second embodiment, the routing length of the connection member 400 from the body wiring lead-out opening 100a of the apparatus body 100 to the second mechanism unit 320 can be shortened as compared with the first embodiment, thereby further reducing degradation of electrical characteristics. As in the first embodiment, the connection member 400 is disposed in the wiring path range 300e, so that the connection member 400 does not overlap the first base 312. Accordingly, the rotation mechanism unit 300 can be made thinner than that in a case where the connection member 400 is disposed in a region outside the wiring path range 300e.

### Third Embodiment

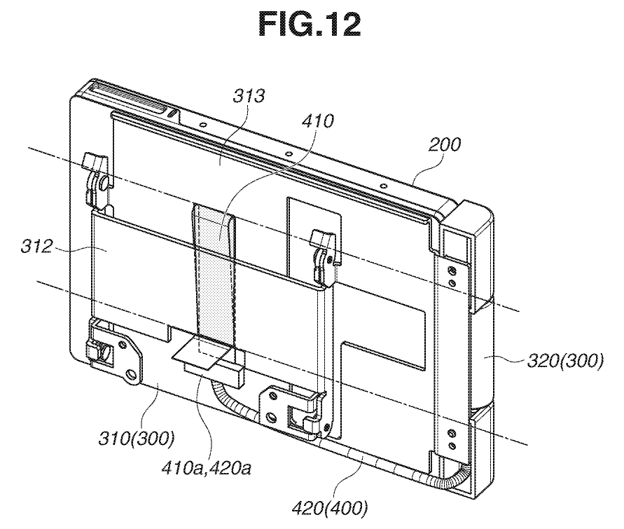

A third embodiment of the present disclosure will be described. FIG. 12 is a perspective view of the display unit 200 and the rotation mechanism unit 300 according to the third embodiment.

An outline of the third embodiment is similar to that of the first embodiment, and differences between the embodiments are described below.

In the present embodiment (FIG. 12), the body wiring lead-out opening 100a and the connection portions 410a and 420a, which are part of the connection member 400 configured to provide both a vari-angle motion and a tilt motion, are aligned along a straight line between the first base 312 and the second base 313. This eliminates the need to extend the body-side connection line 410 in two directions corresponding to two axes so as to connect the body-side connection line 410 and the display-side connection line 420. Consequently, not only can the configuration be simplified, but also the length, in a direction perpendicular to a tilt axis, along which the body-side connection line 410 is extended to connect to the display-side connection line 420, can be reduced.

### Fourth Embodiment

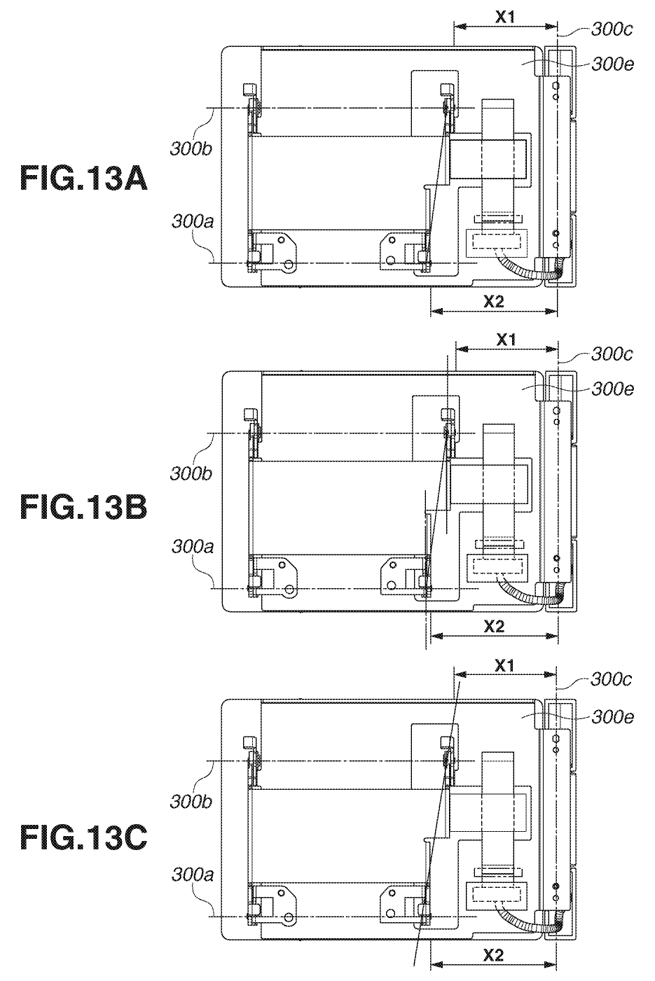

A fourth embodiment of the present disclosure will be described. In the fourth embodiment, an arrangement of the connection member 400 in the first embodiment will be described in more detail. FIG. 13A is a plan view supplemented with additional indications regarding the arrangement of the connection member 400 of FIG. 9A according to the first embodiment. FIG. 13A also illustrates a stored state in which the display unit 200 is stored in the apparatus body 100.

Differences from the first embodiment are described below.

In the fourth embodiment, as illustrated in FIG. 13A, a plurality of bearing portions 310a and a plurality of bearing portions 320a that form the first axis 300a and the second axis 300b are disposed. Among these bearing portions 310a and 320a, a line segment connecting the bearing portion 310a closest to the third axis 300c and the bearing portion 320a closest to the third axis 300c is defined, and an outer region is defined on a side of the line segment toward the third axis 300c. The body-side connection line 410 and the connection portions 410a and 420a are disposed in this region.

This also means that the body-side connection line 410 is disposed in the wiring path range 300e that does not overlap the first base 312. Accordingly, the thickness of the base portion in the optical axis direction when the display unit 200 is stored in the apparatus body 100 can be reduced, thereby contributing to a thinner display apparatus 1.

### Fifth Embodiment

A fifth embodiment of the present disclosure will be described. In the fifth embodiment, the arrangement of the connection member 400 in the first embodiment will be described in more detail. FIG. 13B is a plan view supplemented with additional indications regarding the arrangement of the connection member 400 of FIG. 9A according to the first embodiment. FIG. 13B also illustrates a stored state in which the display unit 200 is stored in the apparatus body 100.

Differences from the first embodiment are described below.

In the fifth embodiment, as illustrated in FIG. 13B, a line segment connecting a bearing portion 310a closest to the third axis 300c and a bearing portion 320a closest to the third axis 300c is defined among a plurality of bearing portions forming the first axis 300a and the second axis 300b. In addition, a straight line parallel to the third axis 300c extends from the line segment in a direction different from a direction in which the line segment is extended from the bearing portion 310a, and another straight line parallel to the third axis 300c extends from the line segment in a direction different from a direction in which the line segment is extended from the bearing portion 320a. The body-side connection line 410 and the connection portions 410a and 420a are disposed in a region between the third axis 300c and the line segment and the two straight lines.

This also means that the body-side connection line 410 is disposed in the wiring path range 300e that does not overlap the first base 312. Accordingly, in a stored state in which the display unit 200 is stored in the apparatus body 100, the thickness of the base portion in the optical axis direction can be reduced, thereby contributing to a thinner display apparatus 1.

### Sixth Embodiment

A sixth embodiment of the present disclosure will be described. In the sixth embodiment, the arrangement of the connection member 400 in the first embodiment will be described in more detail. FIG. 13C is a plan view supplemented with additional indications regarding the arrangement of the connection member 400 of FIG. 9A according to the first embodiment. FIG. 13C also illustrates a stored state in which the display unit 200 is stored in the apparatus body 100.

Differences from the first embodiment are described below.

In the sixth embodiment, as illustrated in FIG. 13C, a region is defined between the third axis 300c and a straight line connecting a bearing portion 310a closest to the third axis 300c and a bearing portion 320a closest to the third axis 300c among a plurality of bearing portions that form the first axis 300a and the second axis 300b. The body-side connection line 410 and the connection portions 410a and 420a are disposed in this region. This also means that the body-side connection line 410 is disposed in the wiring path range 300e that does not overlap the first base 312. Accordingly, in a stored state in which the display unit 200 is stored in the apparatus body 100, the thickness of the base portion in the optical axis direction can be reduced, thus contributing to a thinner display apparatus 1.

While embodiments of the present disclosure have been described above, the present disclosure is not limited to these embodiments, and various modifications and changes can be made without departing from the spirit and scope of the present disclosure. For example, the present disclosure is applicable not only to an image capturing apparatus but also to various other devices having a display unit, such as a personal computer (PC).

### Seventh Embodiment

A seventh embodiment of the present disclosure will be described.

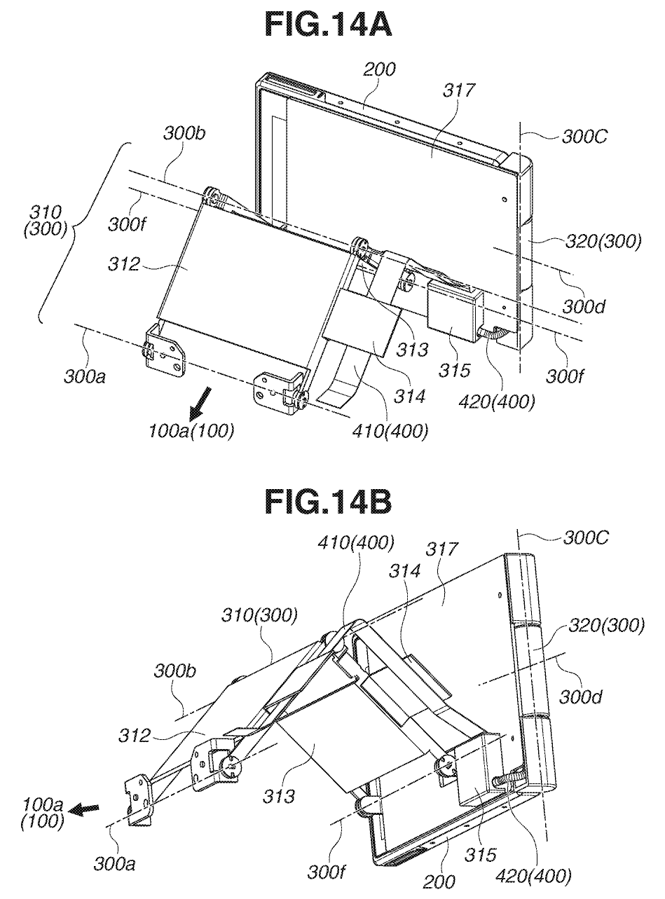

FIGS. 14A and 14B illustrate a perspective view and a side view, respectively, of the display unit 200 and the rotation mechanism unit 300 according to the seventh embodiment. FIG. 14A is a perspective view illustrating the display unit 200 and the rotation mechanism unit 300 as viewed from above.

FIG. 14B is a side view illustrating the display unit 200 and the rotation mechanism unit 300 as viewed from below.

The configuration according to the present embodiment includes the apparatus body 100, as in the first embodiment, but the display unit 200 and the rotation mechanism unit 300 have different configurations. Provided on a rear side of the apparatus body 100 (FIG. 7) is the display unit 200 including a display surface 200a (e.g., FIG. 2) and a display control board for controlling driving of the display surface 200a. The display unit 200 is rotatably supported by the rotation mechanism unit 300 including the first mechanism unit 310 and the second mechanism unit 320. Differences from the first embodiment are described below.

The seventh embodiment has a configuration in which a tilt mechanism with three axes, including a tilt rotation axis in addition to the axes according to the first embodiment, and a vari-angle mechanism are used in combination, and the other components are similar to those of the first embodiment.

Rotation performed by the first mechanism unit 310 and the second mechanism unit 320 in the seventh embodiment, as illustrated in FIGS. 14A and 14B, will be described below.

Referring to FIG. 14A, the first base 312 is formed between the apparatus body 100 and the display unit 200. In FIG. 14A, the apparatus body 100 is disposed in the direction indicated by the arrow. The first base 312 is rotatably supported with respect to the apparatus body 100 about the first axis 300a provided on an apparatus body 100 side of a part of the first mechanism unit 310. The second base 313 is rotatably supported with respect to the first base 312 about the second axis 300b extending from the first base 312 and parallel to the first axis 300a.

As illustrated in FIG. 14B, a fifth axis 300f extends from the second base 313 toward the display unit 200 and is parallel to the second axis 300b. By virtue of the fifth axis 300f serving as a rotation axis, a third base 317 formed on a rear surface of the display unit 200 is rotatably supported with respect to the second base 313. The display unit 200 is rotatable about each of the first axis 300a, the second axis 300b, and the fifth axis 300f, and is also rotatable by a combination of rotations about these axes.

On the third base 317, the second mechanism unit 320 is provided. The second mechanism unit 320 includes the third axis 300c perpendicular to the first axis 300a and the second axis 300b and the fourth axis 300d orthogonal to the third axis 300c. The second mechanism unit 320 is a vari-angle mechanism.

The second mechanism unit 320 is formed of a metal plate material and/or a spring material, and includes the second mechanism assembly 321 (FIG. 5B) that defines the third axis 300c and the fourth axis 300d by forming bearing portions for the third axis 300c and the fourth axis 300d. The second mechanism assembly 321 includes a tubular member that defines the fourth axis 300d, and a part of a display-side connection line 420 extending from the display unit 200 toward the apparatus body 100 is passed through the tubular member toward the display unit 200.

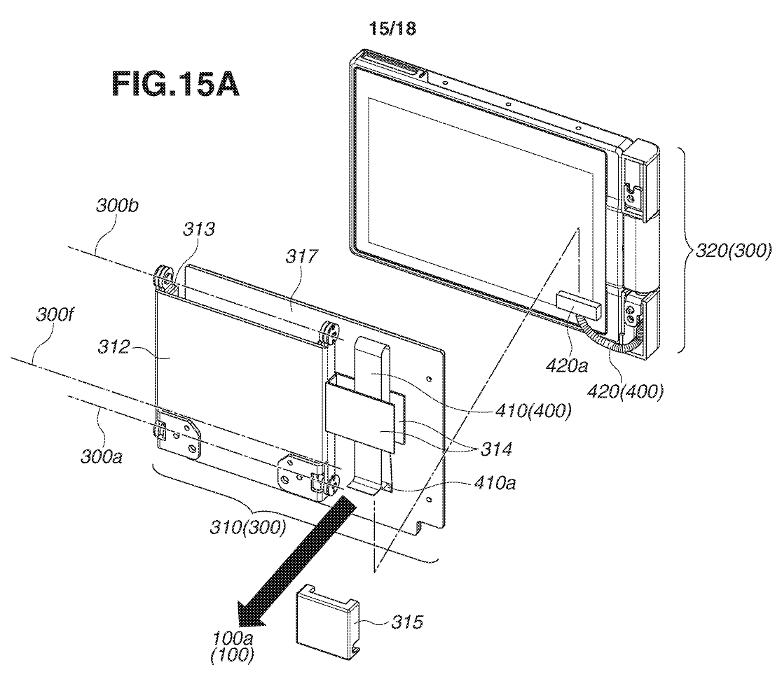

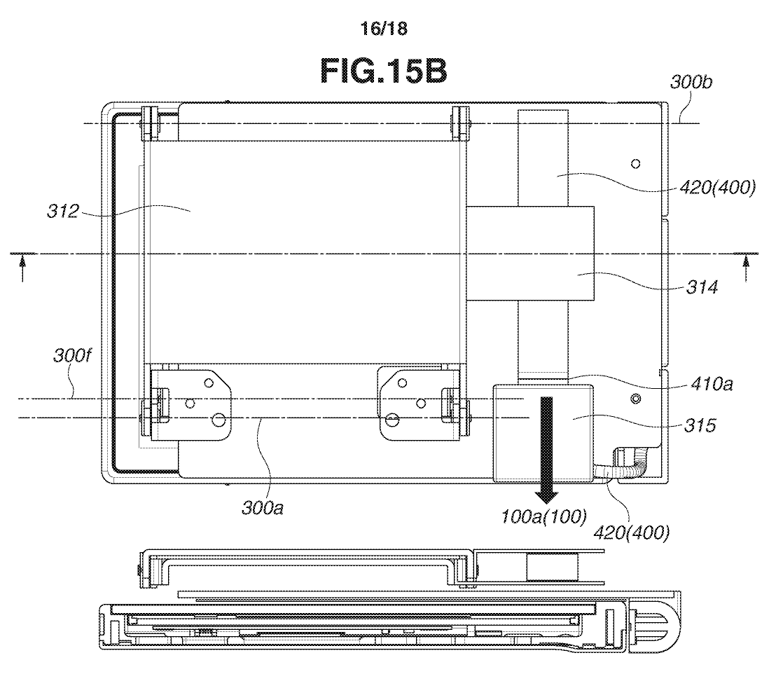

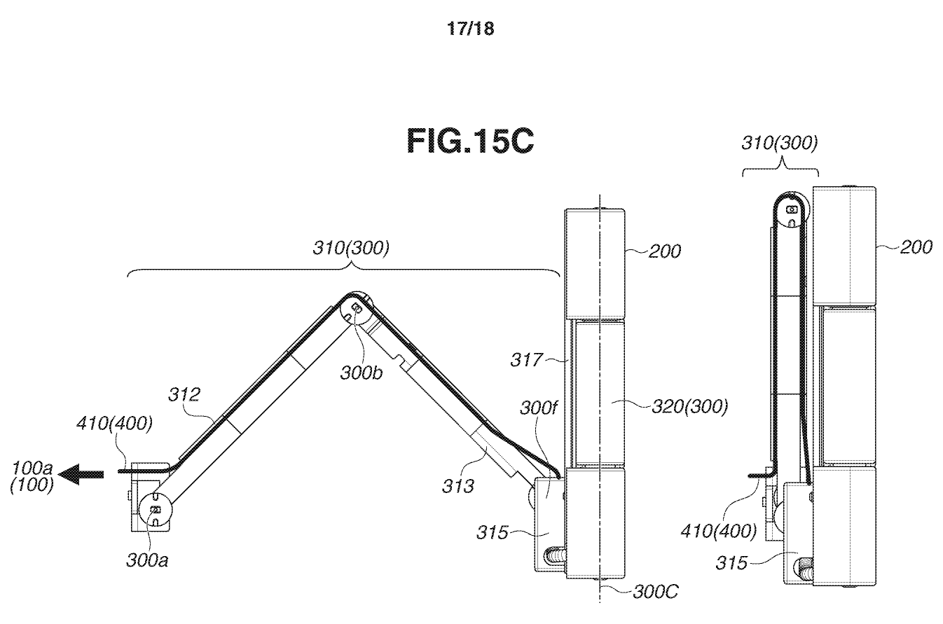

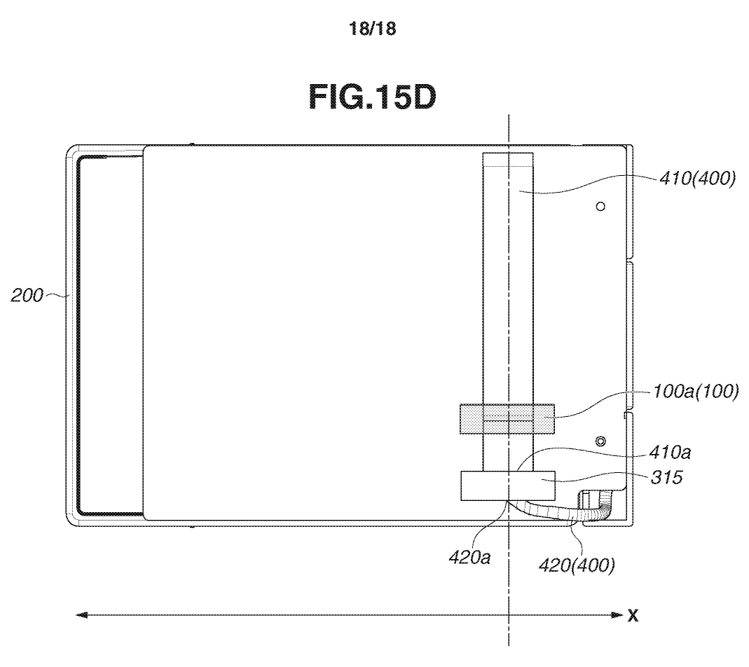

FIG. 15A is an exploded perspective view illustrating an arrangement of the connection member 400. The display-side connection line 420 is supported, with double-sided tape or the like, by the wiring bracket 314 that extends toward the second mechanism unit 320 along a plane parallel to respective surfaces of the first base 312 and the second base 313.

FIG. 15B illustrates a plan view of the display unit 200 and a sectional view taken along a line passing through the wiring bracket 314. On the third base 317, the connection portion cover 315 is provided to cover the connection portions 410a and 420a and a part of the display-side connection line 420 for waterproofing, dustproofing, and the like.

The connection portions 410a and 420a and the connection portion cover 315 are disposed on the second mechanism unit 320 such that, in a stored state, the connection portions 410a and 420a and the connection portion cover 315 do not overlap the first base 312 and the second base 313 in the optical axis direction. Accordingly, the overall thickness of the apparatus in the optical axis direction in the stored state can be reduced, which is advantageous for reducing the size of the display apparatus.

Next, the routing of the connection member 400 will be described with reference to FIGS. 15A and 15C. The connection member 400 includes a body-side connection line 410 and a display-side connection line 420.

FIG. 15C is a side view illustrating a rotated state of the rotation mechanism unit 300 with respect to the display unit 200 and a stored state. The body-side connection line 410 extends from the body wiring lead-out opening 100a (FIG. 7) of the apparatus body 100 on the first-axis 300a side. The body-side connection line 410 extends along the first base 312 and the second base 313. As illustrated in FIG. 15A, the body-side connection line 410 is connected to the display-side connection line 420 via the connection portions 410a and 420a on the third base 317.

The body wiring lead-out opening 100a and the connection portions 410a and 420a are substantially collinear along a line extending in a direction substantially perpendicular to each of the first axis 300a, the second axis 300b, and the fifth axis 300f. This arrangement is substantially similar to that of the first embodiment, in which the above positional relationship is satisfied with respect to the first axis 300a and the second axis 300b, and the seventh embodiment applies that arrangement to also satisfy the relationship with respect to the fifth axis 300f.

FIG. 15D is a projection view in which, on a projected plane obtained by projecting, in a stored state, from a direction perpendicular to the display unit 200, the body wiring lead-out opening 100a, the connection member 400, and the connection portion 410a and the connection portion 420a are arranged. A projected plane is defined by projecting, in the stored state, the body wiring lead-out opening 100a, the connection member 400, and the connection portion 410a and the connection portion 420a from the direction perpendicular to the display unit 200. In this case, on the projection plane, the body wiring lead-out opening 100a and the connection portions 410a and 420a are disposed along a direction of a given straight line that perpendicularly intersects the first axis 300a, the second axis 300b, and the fifth axis 300f.

In other words, on the projection plane, there is a common straight line that passes through the body wiring lead-out opening 100a, the connection portion 410a, and the connection portion 420a. The positions of the body wiring lead-out opening 100a, the connection portion 410a, and the connection portion 420a need not be such that their widths arranged on the straight line are completely aligned, as long as the body wiring lead-out opening 100a, the connection portion 410a, and the connection portion 420a are arranged to have the above-described common straight line passing through them.

With this arrangement in which the body-side connection line 410 is arranged so as to extend along a substantially straight line and to be folded back, the body wiring lead-out opening 100a and the connection portion 410a and the connection portion 420a can be connected. Referring to FIG. 15D, the body-side connection line 410 extends from the lower side toward the upper side in FIG. 15D and is folded back, and thereafter extends downward again so as to be arranged along a substantially straight line.

In other words, when a straight line that is substantially parallel to the first axis 300a, the second axis 300b, and the fifth axis 300f is defined as a straight line X, the body wiring lead-out opening 100a, the connection portion 410a, and the connection portion 420a are arranged on a straight line that is orthogonal to the straight line X on the projection plane. In other words, the body wiring lead-out opening 100a, the connection portion 410a, and the connection portion 420a are arranged on a substantially straight line, and the widths of the body wiring lead-out opening 100a, the connection portion 410a, and the connection portion 420a have a common straight line that intersects the straight line X perpendicularly.

The relationship of arrangement among the body wiring lead-out opening 100a, the connection member 400, and the connection portion 410a and the connection portion 420a in the present embodiment described above is similar to the relationship of arrangement illustrated in FIGS. 9A and 9B of the first embodiment and the relationship of arrangement illustrated in FIGS. 13A to 13C of the fourth embodiment.

Assume that the body wiring lead-out opening 100a (FIG. 7), the connection portion 410a, and the connection portion 420a are misaligned in a direction parallel to each of the first axis 300a, the second axis 300b, and the fifth axis 300f on the projection plane in the optical axis direction in the stored state. Herein, "misaligned" means that the body wiring lead-out opening 100a, the connection portion 410a, and the connection portion 420a are disposed at positions different from one another in the direction parallel to the first axis 300a, the second axis 300b, and the fifth axis 300f. In particular, on the projection plane illustrated in FIG. 15D, the respective widths of the body wiring lead-out opening 100a and the connection portions 410a and 420a that are disposed substantially on the same straight line do not share a common straight line that intersects a straight line X perpendicularly.

In this case, it becomes necessary to extend the body-side connection line 410 for connection also in a direction parallel to the first axis 300a, the second axis 300b, and the fifth axis 300f.

On the other hand, according to the seventh embodiment, the body-side connection line 410 can be connected to the display-side connection line 420 at the connection portions 410a and 420a by extending the body-side connection line 410 only in one direction. Specifically, the body-side connection line 410 needs only to be extended in the arrow direction illustrated in FIG. 15B, and there is no need to extend the body-side connection line 410 in a direction orthogonal to the arrow direction on the projection plane. In other words, in the configuration illustrated in FIG. 15B, there is no need to extend the body-side connection line 410 in the horizontal direction in the plane of FIG. 15B, and it is sufficient to extend the body-side connection line 410 in the vertical direction. In other words, in the seventh embodiment, there is no need to turn back or bend the body-side connection line 410 toward a direction parallel to the straight line X.

The body wiring lead-out opening 100a and the connection portions 410a and 420a may be arranged along a direction substantially perpendicular to at least one of the first axis 300a, the second axis 300b, and the fifth axis 300f.

As described above, also in the tilt mechanism having three rotation axes, the configuration can be simplified as in the first embodiment. Further, the length in a direction perpendicular to a tilt axis, for extending the body-side connection line 410 to connect to the display-side connection line 420, can be reduced. A complicated layout of the body-side connection line 410 in two directions corresponding to two axes is not required, and the body-side connection line 410 can be arranged with a simple folded-back configuration.

The present disclosure is not limited only to these embodiments and can be modified and altered in various ways without departing from the gist of the present disclosure. For example, the present disclosure can be applied to an image capturing apparatus, as well as to other devices including a display unit, such as a personal computer (PC).

Accordingly, an apparatus that can be manufactured at a reduced cost as compared with those in conventional techniques can be realized.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Applications No. 2025-062990, filed Apr. 7, 2025, and No. 2025-177273, filed Oct. 21, 2025, which are hereby incorporated by reference herein in their entirety.

What is claimed is:

1. A display apparatus comprising:
an apparatus body;
a display unit including a display surface;
a first base;
a second base;
a rotation unit configured to rotatably support the display unit with respect to the apparatus body; and
a connection member configured to electrically connect the apparatus body and the display unit,
wherein the first base is rotatably supported about a first axis with respect to the apparatus body, and the second base is rotatably supported with respect to the first base about a second axis parallel to the first axis, with the first base and the second base provided between the apparatus body and the display unit,
wherein the rotation unit includes the first axis, the second axis, and a third axis that is perpendicular to the first axis in a stored state in which the display unit is stored in the apparatus body, the display unit being rotatable with respect to the second base about the third axis,
wherein the connection member includes a first connection line extending from a wiring lead-out opening of the apparatus body and extending in a direction from the first axis toward the second axis, a second connection line extending from the display unit, and a connection portion connecting the first connection line and the second connection line, and
wherein the wiring lead-out opening of the apparatus body and the connection portion are disposed along a direction perpendicular to at least one of the first axis and the second axis.

2. The display apparatus according to claim 1,
wherein the rotation unit further includes a fourth axis orthogonal to the third axis, and
wherein a portion of the second connection line passes between components that form the fourth axis.

3. The display apparatus according to claim 1, wherein, in the stored state in which the display unit is stored in the apparatus body, the first connection line and the connection portion are disposed in a region between the third axis and (i) a bearing portion, forming the first axis, closest to the third axis, among a plurality of bearing portions forming the first axis, and (ii) a bearing portion, forming the second axis, closest to the third axis, among a plurality of bearing portions forming the second axis.

4. The display apparatus according to claim 2, wherein, in the stored state in which the display unit is stored in the apparatus body, the first connection line and the connection portion are disposed in a region between the third axis and (i) a bearing portion, forming the first axis, closest to the third axis, among a plurality of bearing portions forming the first axis, and (ii) a bearing portion forming the second axis, closest to the third axis, among a plurality of bearing portions forming the second axis.

5. The display apparatus according to claim 3, wherein, in the stored state in which the display unit is stored in the apparatus body, a line segment connecting (i) the bearing portion, forming the first axis, closest to the third axis among the plurality of bearing portions forming the first axis, and (ii) the bearing portion, forming the second axis, closest to the third axis among the plurality of bearing portions forming the second axis is defined, and the first connection line and the connection portion are disposed outside the line segment on a side toward the third axis.

6. The display apparatus according to claim 4, wherein, in the stored state in which the display unit is stored in the apparatus body, a line segment connecting (i) the bearing portion, forming the first axis, closest to the third axis among the plurality of bearing portions forming the first axis, and (ii) the bearing portion, forming the second axis, closest to the third axis among the plurality of bearing portions forming the second axis is defined, and the first connection line and the connection portion are disposed outside the line segment on a side toward the third axis.

7. The display apparatus according to claim 3, wherein, in the stored state in which the display unit is stored in the apparatus body, the first connection line and the connection portion are disposed between the third axis and a straight line connecting (i) the bearing portion, forming the first axis, closest to the third axis among the plurality of bearing portions forming the first axis and (ii) the bearing portion, forming the second axis, closest to the third axis among the plurality of bearing portions forming the second axis.

8. The display apparatus according to claim 4, wherein, in the stored state in which the display unit is stored in the apparatus body, the first connection line and the connection portion are disposed between the third axis and a straight line connecting (i) the bearing portion, forming the first axis, closest to the third axis among the plurality of bearing portions forming the first axis and (ii) the bearing portion, forming the second axis, closest to the third axis among the plurality of bearing portions forming the second axis.

9. The display apparatus according to claim 2, wherein the connection member is configured such that the first connection line extends from the wiring lead-out opening of the apparatus body in a vicinity of the first axis and is connected to the second connection line via the connection portion, and a portion of the second connection line extending from the connection portion is connected to the display unit via the second mechanism unit including the third axis and the fourth axis, from a vicinity of the second axis.

10. The display apparatus according to claim 1, wherein, in the stored state in which the display unit is stored in the apparatus body, the first connection line is bent between the wiring lead-out opening of the apparatus body and the connection portion, and has a first region in which a portion of the first connection line extending from the wiring lead-out opening of the apparatus body to a point of the bending overlaps a portion of the first connection line folded back after the bending.

11. The display apparatus according to claim 2, wherein, in the stored state in which the display unit is stored in the apparatus body, the first connection line is bent between the wiring lead-out opening of the apparatus body and the connection portion, and has a first region in which a portion of the first connection line extending from the wiring lead-out opening of the apparatus body to a point of the bending overlaps a portion of the first connection line folded back after the bending.

12. The display apparatus according to claim 10, wherein the connection member is configured such that the first connection line extends from the wiring lead-out opening of the apparatus body in a vicinity of the first axis and is bent in a vicinity of the second axis to form the first region, and is connected to the second connection line via the connection portion, and a portion of the second connection line extending from the connection portion is connected to the display unit via the second mechanism unit including the third axis and the fourth axis, from the vicinity of the first axis.

13. The display apparatus according to claim 11, wherein the connection member is configured such that the first connection line extends from the wiring lead-out opening of the apparatus body in a vicinity of the first axis and is bent in a vicinity of the second axis to form the first region, and is connected to the second connection line via the connection portion, and a portion of the second connection line extending from the connection portion is connected to the display unit via the second mechanism unit including the third axis and the fourth axis, from the vicinity of the first axis.

14. The display apparatus according to claim 3, wherein, in the stored state in which the display unit is stored in the apparatus body, the first connection line does not overlap the first base or the second base in an optical axis direction.

15. The display apparatus according to claim 4, wherein, in the stored state in which the display unit is stored in the apparatus body, the first connection line does not overlap the first base or the second base in an optical axis direction.

16. The display apparatus according to claim 1, wherein, in the stored state in which the display unit is stored in the apparatus body, when a distance between the second axis and the connection portion is defined as L1 and a distance between the second axis and the wiring lead-out opening of the apparatus body is defined as L2, L1 is greater than L2.

17. The display apparatus according to claim 1, wherein at least one of the connection portion and the first connection line is supported by a wiring bracket formed or fastened along an extending direction A of at least one of the first base or the second base.

18. The display apparatus according to claim 3, wherein, in the stored state in which the display unit is stored in the apparatus body, a distance between the third axis and the bearing portion, forming the first axis, closest to the third axis in an optical axis direction differs from a distance between the third axis and the bearing portion, forming the second axis, closest to the third axis in the optical axis direction.

19. An image capturing apparatus, comprising:
the display apparatus according to claim 1; and
an image sensor in the apparatus body.

20. The display apparatus according to claim 1, wherein the first connection line is arranged without being bent toward a direction parallel to at least one of the first axis and the second axis.
